(19) United States
(12) Patent Application Publication
(10) Pub. No.: US 2005/0198877 A1
(43) Pub. Date: Sep. 15, 2005

(54) Product display system

(76) Inventor: Aaron M. Lamstein, San Rafael, CA (US)

Correspondence Address: DERGOSITS & NOAH LLP, Suite 1450, Four Embarcadero Center, San Francisco, CA, 94111, US

(21) Appl. No.: 10/801,258

(22) Filed: Mar. 15, 2004

(51) Int. Cl. G09F 3/10

(52) U.S. Cl. 40/299.01

(57) ABSTRACT

A system for displaying multiple packages for purchase by consumers. A segmented display is provided that identifies characteristics of a single entity and codes each segment of the segmented display to differentiate each characteristic from other characteristics of the segmented display. Multiple packages are positioned proximate the segmented display, each of the multiple packages further exhibiting at least one of the codes to enable a consumer to associate a package with a characteristic of the entity.

### TECHNICAL FIELD OF INVENTION

A system for displaying multiple packages for purchase by consumers. A segmented display is provided that identifies characteristics of a single entity and codes each segment of the segmented display to differentiate each characteristic from other characteristics of the segmented display. Multiple packages are positioned proximate the segmented display, each of the multiple packages further exhibiting at least one of the codes to enable a consumer to associate a package with a characteristic of the entity.

### BACKGROUND OF THE INVENTION

Retailers and consumers oftentimes share the same frustration resulting from the inability of the retailer to communicate enough information to the purchaser to enable the purchaser to make informed purchasing decisions quickly and effectively. This problem is of particular concern to large retailers who sell thousands and products, many of which are of low cost. A clear goal of such retailers is to enable a consumer to make an informed purchasing decision quickly in order to encourage efficient and sustained sales activity and volume.

From the consumers standpoint, again, when in need of a relatively low cost but competitive product it is often times been a frustrating experience to differentiate products not only between manufacturers but also within a particular manufacturer's product line.

Although the present invention is not limited to pet products, an example of the challenges facing retailers and consumers can best be exemplified in considering products offered to pet owners such as those that own dogs, cats or birds. Such products are generally low cost items and each such item is generally shelved by retailers together with competing items which offer little or no differentiation as to cost or utility. Confusion is exacerbated in that the consumer often is unaware as to the purpose or nature of the pet-related item being vended. Stated differently, the consumer is not told whether the item being offered for sale is a toy or novelty item or whether it performs a constructive function as it pertains to the animal's well-being. Clearly, there is a need for improved customer education and awareness particularly as it pertains to relatively low cost competitive commercial products.

It is thus an object of the present invention to provide a system for displaying multiple packages for purchase by consumers in a way that improves the consumer's ability to make informed purchasing decisions.

These and further objects will be more readily apparent when considering the following disclosure and appended drawings.

### SUMMARY OF THE INVENTION

A system for displaying multiple packages for purchase by consumers. The system comprises a segmented display that identifies characteristics of a single entity and codes each segment of the segmented display to differentiate each characteristic from other characteristics of the segmented display. The segmented display is positioned proximate to the multiple packages offered for sale, each of the multiple packages further exhibiting at least one of the codes, such as color, numeral or alphabetic codes, to enable a consumer to associate a package with a characteristic of the entity.

### BRIEF DESCRIPTION OF THE FIGURES

FIG. 1 is a plan view of a segmented display for use in practicing the present invention.

FIG. 2 is a plan view of a typical multiple package layout for use in conjunction with the segmented display of FIG. 1 in carrying out the present invention.

### DETAILED DESCRIPTION OF THE INVENTION

Although the present invention can be extended to virtually any “entity,” the invention is particularly well suited for the sale of low cost highly competitive goods where a good deal of forethought is not required in making a purchase. Such goods are often times characterized as being “impulse” items as consumers often purchase such goods on impulse and without forethought. Pet products such as those purchased for domestic pets such as dogs, cats or birds typify the types of goods which lend themselves to the practice of the present invention.

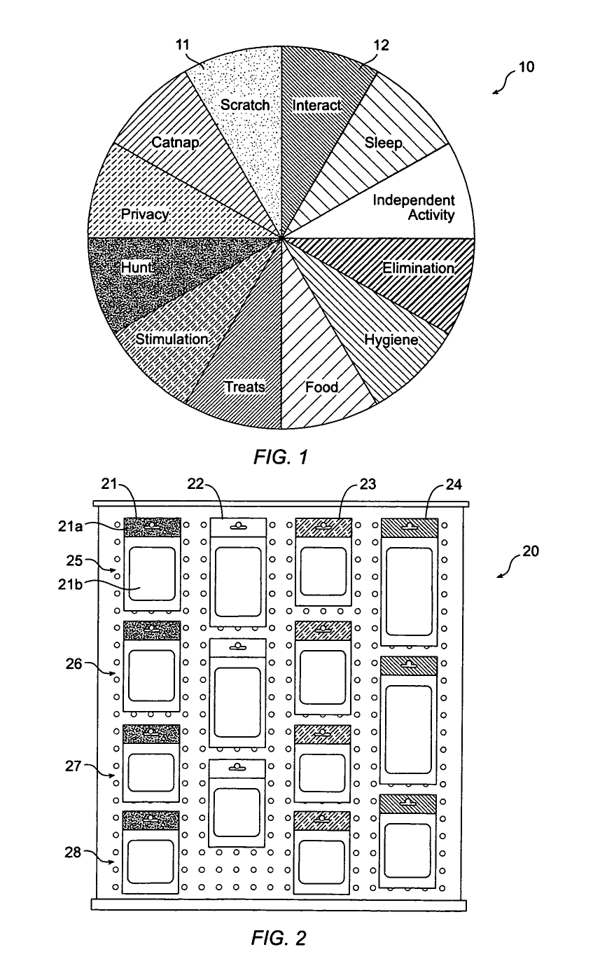

As an illustration, FIG. 1 depicts a typical segmented display for use in the sale of cat-related products. In this illustration, display 10 is in the form of a pie chart having segmented pie shaped portions 11 and 12, etc. The first step in practicing the present invention is to identify the needs of the entity, in this illustration, a domestic cat. As noted, all of a cat's perceived needs such as the need to scratch (11), interact (12), sleep, engage in independent play, bodily elimination, hygiene, food, treats, stimulation, hunting, privacy and catnip have been recited as 12 basic functions which a healthy and happy domesticated cat must engage in or employ. Each of the pie chart sections, 11, 12, etc. not only recite a different need or function, each is coded for reasons which become quite apparent hereinafter.

As noted, segmented display 10 is intended to be presented to a consumer in connection with the sale of goods in the form of “multiple packages” 20 (FIG. 2). Multiple packages 20 are displayed on, for example, peg bar hooks (not shown) in columns 21, 22, 23 and 24 and rows 25, 26, 27 and 28. Ideally, there would be as many columns as there are segmented portions 11, 12, etc. on segmented display 10 such that a consumer would first go to segmented display 10 in order to identify the need or want of one's pet cat which would be recited on one of the segmented portions, 11, 12, etc., and coded by color, number or letter. The consumer would then proceed to the peg bar display 20 to identify the column whereby the coding relating to the cat's want or need is presented. For example, column 21 could have various products involved in hunting. Most preferably, the “hunt” segment of segmented display 10 would be of a specific color while the border region 21a would display the same color for ready identification. In this way, a consumer not wishing to spend an inordinate amount of time in the purchase of relatively low cost “impulse” products for one's pet cat would immediately be informed of the various needs and wants of the cat and if a decision is made to buy pet products dealing with the cat's need to hunt, the consumer would immediately proceed to column 21 as a result of matching border color 21a with the same color applied to the “hunt” segment of display 10. The actual product could be seen encased in a clear vacuum formed region 21b or displayed in any other fashion.

Once a consumer is within the appropriate column, the present invention contemplates, as a preferred embodiment, structuring goods within that column in a predetermined ascending or descending order. For example, in column 21, goods 25, 26, 27 and 28 could be arranged in ascending or descending order according to, for example, cost efficiency or complexity. As such, a consumer would be in a position, through the practice of the present invention, to immediately locate a grouping of products which intend to satisfy a particular need, and then make a further decision as to the specific product to be purchased based upon price and related factors.

It is quite apparent that if the present invention was not practiced, a consumer would find it extremely difficult to chose the appropriate product for one's pet. Not only do individual manufacturers offer a plethora of seemingly redundant pet-related items, but large retailers carry related products by multiple manufacturers which, often times, are for products which are difficult to differentiate. By practicing the present invention, the consumer can be immediately directed to a need or want of an “entity” such as a pet and be directed to a product to satisfy this need or want and to further be empowered to make a selection within a particular category based upon price, complexity and related factors.

1. A system for displaying multiple packages for purchase by consumers, said system comprising a segmented display that identifies characteristics of a single entity and codes each segment of said segmented display to differentiate each characteristic from other characteristics of said segmented display and positioning said multiple packages proximate said segmented display, each of said multiple packages further exhibiting at least one of said codes to enable a consumer to associate a package with a characteristic of said entity.

2. The system of claim 1 wherein said code is a color code.

3. The system of claim 1 wherein said code is a numeric code.

4. The system of claim 1 wherein said code is an alphabetic code.

5. The system of claim 1 wherein said segmented display is a pie chart display.

6. The system of claim 1 wherein said single entity is a domestic pet and said multiple packages comprised health or exercise related products for said domestic pet.

7. The system of claim 6 wherein said domestic pet comprises a member selected from the group consisting of dogs, cats and birds.

8. The system of claim 1 wherein said multiple packages are displayed in sub groups of more than one package per sub group, all packages within each sub group being related by displaying a common code.

9. The system of claim 8 wherein packages displayed within said sub groups are displayed in a predetermined ascending or descending order.

10. The system of claim 9 wherein said order is determined by the cost of each package.

11. The system of claim 9 wherein said order is determined by the efficacy or complexity of each item.
